(19) United States
(12) Patent Application Publication
(10) Pub. No.: US 2006/0111925 A1
(43) Pub. Date: May 25, 2006

(54) Method and system for tool management

(76) Inventors: Franz Hollich, Sinheim (DE); Harald Kluge, Sinsheim (DE); Martin Loitz, Nussloch (DE)

Correspondence Address: KENYON & KENYON LLP, 1500 K STREET N.W., SUITE 700, WASHINGTON, DC, 20005, US

(21) Appl. No.: 11/026,059

(22) Filed: Jan. 3, 2005

Related U.S. Application Data
(60) Provisional application No. 60/630,300, filed on Nov. 24, 2004.

(51) Int. Cl. G06Q 99/00

(52) U.S. Cl. 705/1

(57) ABSTRACT

The method and system tool management. Tools are classified as either material tools or equipment tools. Tools are reserved via generation of a use reservation indicating when a user will obtain and use the tool and a return reservation indicating when a user will return the tool. The present invention provides that before a tool is reserved, an availability check is performed in order to ensure that the tool is available for use at a certain period of time. A user interface for reserving tools is provided by the method and system of the present invention. Additionally, the present invention provides for recording the time when tools are issued for used and the time when tools are returned after use.

### BACKGROUND INFORMATION

In a business environment, various items may used to perform business activities. In other systems, all items are classified as materials. Materials are items that are managed quantitatively. Materials include all items required for performing business activities such as printers, forklifts, hangars, measuring devices, paint, screwdrivers, hammers, etc. Materials are reserved for use via a standard reservation indicating a period of time when a user will obtain and use the material.

Other systems for materials management include SAP R/3 which includes materials management functionality. In SAP R/3, all items for performing business activities are classified and processed as materials. The SAP R/3 system provides a core transaction system for logistics, financials, and human resources management. Also, SAP R/3 provides core financial, accounting, controller, sales and distribution, materials management and order processing functionality. The SAP R/3 provides a wide range of business applications for a client/server computer network with a three-tier hierarchy: (1) user interface, (2) business logic layer, and (3) database layer. The SAP R/3 system may serve as a back-end system in a computer network. Furthermore, a computer network may include the SAP Basis system that includes middleware software that functions as a conversion or translation layer between two different layers, the front-end system (SAP CRM) and the back-end system (SAP R/3). The SAP CRM system functions as a front-end system in a computer network. SAP CRM provides customer relationship management functionality for managing interaction with customers, automatic sales, e-commerce, customer services and order processing. SAP CRM also provides supplier relationship management (SRM) for procurement of material from suppliers and supply chain management (SCM) which extends a supply chain to manufacturers, suppliers, and distributors.

### BRIEF DESCRIPTION OF THE DRAWINGS

FIG. 1 shows a system according to the present invention.

FIG. 2 shows an exemplary embodiment of a method of the present invention.

FIG. 3 shows another exemplary embodiment of a method of the present invention.

### DETAILED DESCRIPTION

The method and system of the present invention provides for tool management. In a business environment, various tools may used to perform business activities. For example, tools such as a forklift, screwdriver, paint, etc. may be used in a warehouse. The tools may be managed in order to increase organizational efficiency in the work environment.

The present invention provides for the management of tools such that tools are classified as either material tools or equipment tools. A material tool is a stock item that is managed quantitatively and may not be identified uniquely, e.g., paint, screwdrivers and hammers. Material tools may be plentiful and easily procured. An equipment tool is a work critical item that is managed and stored as an individual object and it may be uniquely identified by a serial number or identification number, e.g., printer, forklift, hangar, measuring device, etc. Equipment tools are individual tools that are valuable or difficult to procure.

A graphical user interface for reserving tools for use in the work environment is provided by the method and system of the present invention. Tools are reserved via generation of a use reservation and a reserve reservation. The use reservation indicates when a user will obtain and use a tool. A return reservation indicates when a user will return the tool. The present invention provides that before a tool is reserved, an availability check is performed in order to ensure that the tool is available for use at a certain period of time. The availability check for a material tool involves determining whether there is enough of the material tool (e.g., screwdrivers) in stock. The availability check for an equipment tool involves determining whether the specific equipment tool (e.g., printer) is available. The availability check may use a tool identification number and/or a tool category to determine tool availability. Additionally, the present invention provides for recording the time when tools are issued for use by a worker and the time when tools are returned after use by a worker. Recording of issue time and return time may be executed via tracking of tool identification numbers and use of a database including tool data records.

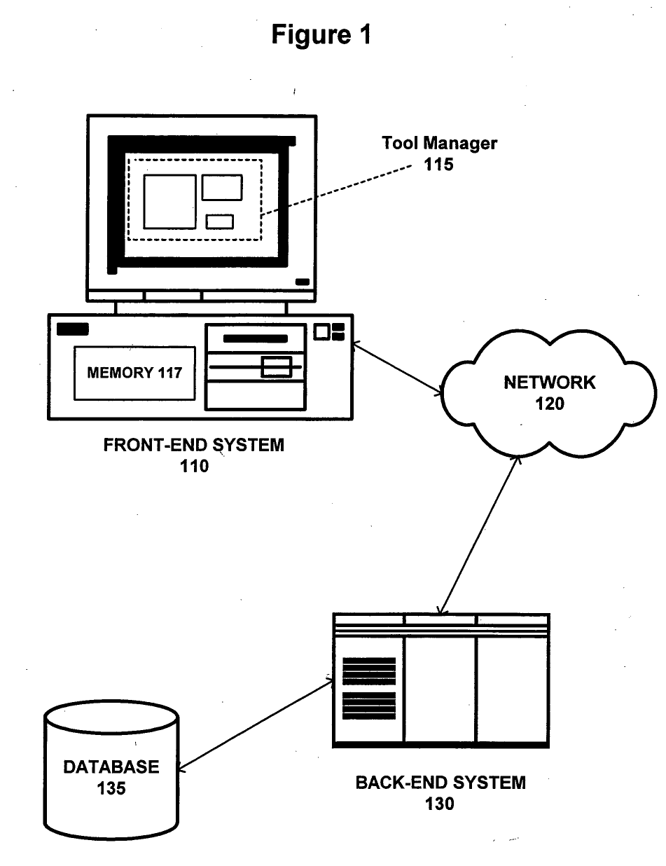

FIG. 1 shows a system according to the present invention. The system includes a front-end system 110, a network 120, a back-end system 130 and a database 135. Front-end system 110 may be any type of device for running application software, such as for example a personal computer, a terminal, a personal digital assistant (PDA), etc. Network 120 may be any type of network for communicating information, such as a local area network (LAN), wide area network (WAN), the Internet, or an Intranet. Back-end system 130 may be a terminal server, mainframe computer, or any type of computer system that services users over network 120. Typically, many front-end systems may be coupled to back-end system 130 through network 120. As shown, back-end system 130 is coupled to database 135, which may be any type of computer readable medium, such as one or more hard disk memories, that stores instructions and data for a knowledge warehouse system that maintains a collection of data to support a decision making process. The back-end system 130 may include various software applications, e.g., SAP R/3. Furthermore, the back-end system 130 uses the database 135 to store and process tool data regarding serial numbers, identification numbers, tool categories, tool description, weight, measure, unit, tool locations, ownership, tool reservation, tool issue, tool return, etc.

As shown in FIG. 1, front-end system 110 displays the interface of the tool manager application 115. In some embodiments, a user running an application program on front-end system 110 may be prompted to enter information into data entry fields of the interface of the tool manager 115. Front-end system 110 also contains a memory 117, which may be for example a Random Access Memory (RAM). The front-end system 100 may include various software applications, e.g., SAP Customer Relationship Management (CRM).

The tool manager 115 of the present invention differentiates between two types of tools, equipment tools and material tools. Equipment tools are individual tools that have serial numbers, e.g., a printer and a forklift. Material tools are mass quantity materials, e.g., screwdrivers. A user operates the interface of the tool manager 115 to reserve a tool for a certain period of time. Tools are reserved via generation of a use reservation and a reserve reservation. The use reservation indicates when a user will obtain and use a tool. A return reservation indicates when a user will return the tool.

In order to process a tool reservation according to the present invention, the tool manager 115 performs a tool availability check to ensure that the tool is available for use at a certain period of time. The present invention provides that before a tool is reserved, an availability check is performed in order to ensure that the tool is available for use at a certain period of time. For example, a user may operate the graphical interface of the present invention in order to execute an availability check for a tool. The availability check for a material tool involves determining whether there is sufficient supply of the material tool (e.g., screwdriver) in stock. The availability check for an equipment tool involves determining whether the specific equipment tool (e.g., forklift) is available. The availability check may use a tool identification number and/or a tool category to determine tool availability. Additionally, the present invention provides for recording the time when tools are issued to a user and the time when the user returns the tools. Recording of issue time and return time may be executed via tracking of tool identification numbers and use of a database including tool data records.

A user may reserve a tool by using a service order that is displayed on the front-end system 110. The service order indicates a task that is to be performed in a work environment. For example, workers in a warehouse may interact with a service order indicating tasks for storage of items. In this case, the warehouse workers may reserve a forklift in order to fulfill the service order for storage. A user may interact with a service order to generate a service template indicating all tools required for a standard task. For example, an elevator repair service order may be used to generate a service template that includes all tools required for the elevator repair task. In another embodiment of the present invention, a user may directly reserve a tool in the tool manager 115. In this case, a tool is reserved without interaction with a service order.

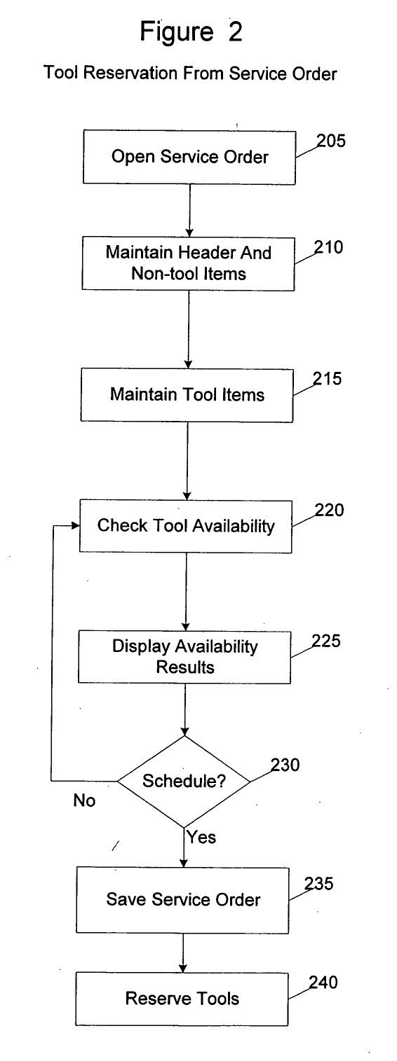

FIG. 2 shows an exemplary embodiment of a method of the present invention. A method for tool reservation from a service order is shown in FIG. 2. In step 205, a user opens a service order on the front-end system 110. The service order indicates a task that is to be performed in a work environment. Next in step 210, the header and non-tool data of the service order are maintained and stored in the back-end system 130. The header of the service order indicates the task to be performed in the work environment and the non-tool data of the service order may include data regarding personnel, date and time of task performance, and other task related data. Then in step 215, the tool items of the service order are maintained and stored in the back-end system 130. The tool items of the service order include data regarding tools that are required for performing a task in a work environment. In step 220, the user requests performance of a tool availability check. The tool availability check determines the tool availability on the basis of the tool items and date and time specified in the service order and on the basis of tool data stored in the back-end system 130. Then in step 225, the tool availability results are displayed. The tool availability results indicate when the tools are available to be reserved and used. In step 230, the user is prompted to schedule a tool reservation for a period of time. If the user does not schedule a tool reservation, step 220 is repeated in order to allow the user to check for tool availability at another period of time. If the user does schedule a tool reservation, step 235 is performed such that the service order is saved in the backend system 130. Then in step 240, the tools are reserved and a tool reservation is generated and stored in the back-end system.

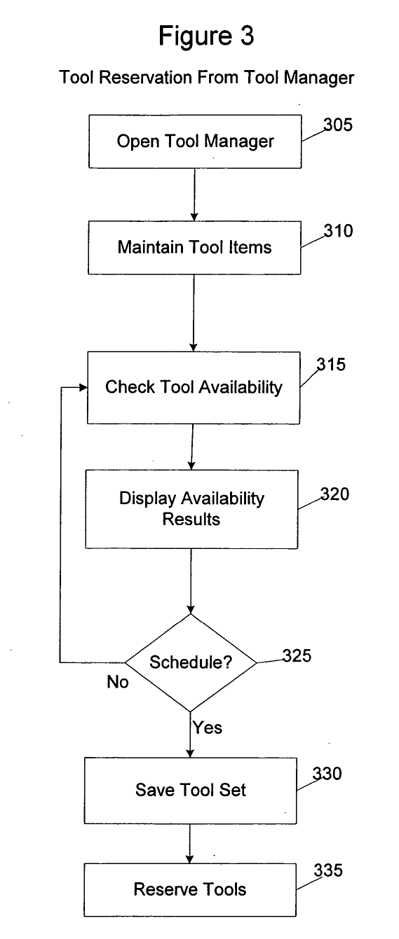

FIG. 3 shows an exemplary embodiment of a method of the present invention. A method for tool reservation from the tool manager is shown in FIG. 3. In step 305, a user opens the tool manager 115 on the front-end system 110. The user interacts with the tool manager 115 to indicate at least one tool to be reserved. A user may reserve an equipment tool by indicating the serial number or identification number of the equipment tool in the tool manager 115. The user interacts with the tool manager to indicate a date and time for tool reservation such that the user enters a period of time when the tool reservation begins and ends. Also, the user may use the tool manager 115 to indicate a specific quantity of tools required and enter the location of the tool. Next in step 310, the tool items to be reserved are maintained and stored in the back-end system 130. The tool items include data regarding tools such as identification number, tool category, serial number and tool reservation date and time. In step 315, the user requests performance of a tool availability check. The tool availability check determines the tool availability on the basis of the tool items and date and time specified in the tool reservation and on the basis of tool data stored in the back-end system 130. Tool data may be stored in database records in the back-end system 130. Tool database records may include tool data regarding serial numbers, identification numbers, tool categories, description, weight, measure, unit, tool locations, ownership, tool reservations, tool issue, tool return, etc. Then in step 320, the tool availability results are displayed. The tool availability results indicate when the tools are available to be reserved and used. In step 325, the user is prompted to schedule a tool reservation for a period of time. If the user does not schedule a tool reservation, step 315 is repeated in order to allow the user to check for tool availability at another period of time. If the user does schedule a tool reservation, step 330 is performed such that a tool set is saved in the backend system 130. The tool set indicates all the tools the user has reserved via the tool manager 115. Then in step 335, the tools are reserved and a tool reservation is generated and stored in the back-end system. The tool reservation includes a tool issue reservation that provides for a reservation start date and a tool return reservation (negative reservation) that provides for cancellation of the issue reservation and a reservation end date.

In another exemplary embodiment of a method of the present invention, a service template is displayed via the computer system. A user may interact with the service template that indicates all tools required for performance of a standard work environment activity or task. For example, the service template corresponds to a work environment activity such as elevator repair and the template lists all tools required for the elevator repair task. The user interacts with the service template via the computer system in order to select which tools the user needs to reserve. A database records the tool selection made by user via the service template. The database is used by the system of the present invention in order to check for a period of time when all the tools required or selected for the activity are available. A notification is displayed by the computer system and it indicates to the user the period of time when the tools are available. The notification proposes at least one period of time when all the tools are available to the user. The user may interact with the notification in order to accept or reject the at least one period of time. The computer system of the present invention records the acceptance or rejection of the at least one period of time by the user. The determination of user as to the at least one period of time is recorded in the database.

An exemplary embodiment of a graphical interface for tool reservation via a service order may include a tool tab for performing a tool reservation via the service order. A data entry field may be used to reserve a tool via item number, product, quantity, description, and the reservation start date and reservation end date. Multiple tools may be reserved via user interaction with the data entry fields of the graphical interface. Also, the graphical interface includes a schedule tab for viewing and displaying the reservation schedule of a tool. The reservation schedule includes a schedule type, a date, quantity and confirmation.

Another exemplary embodiment of a graphical interface for tool reservation via a tool manager may include a search field that a user may use to retrieve information regarding a tool's current location, user and other details via a start search tab.

The graphical interface displays tool data including a product name, description, location, quantity and reservation start and end information. Also, the graphical interface displays a tool reservation schedule and the user may interact with data entry fields in order to reserve a tool.

The method according to the present invention may be stored as a set of instructions that is accessible and executable by a processor. The processor may include a computer server arrangement. The set of instructions may be stored on a machine readable medium that us any medium capable of being read by a machine such as a compact disk, hard drive memory, floppy disk memory, DVD-ROM, CD-ROM or any type of machine-readable (computer-readable) storing medium. The set of instructions may be included within a computer program (which as is well known comprises a plurality of instructions) that is executable by a computer system.

The above is a detailed discussion of the certain embodiments. It may be understood that the examples discussed are for illustration purposes only and are not intended to limit the configuration to that shown. For example, the order of the steps performed may be varied where appropriate. It is of course intended that the scope of the claims may cover other embodiments than those described above and their equivalents.

What is claimed is:

1. A method for management of a tool, the method comprising:
creating a service order for the tool;
storing the service order in a database of a computer system, the database including tool data;
checking availability of the tool at a period of time via the database; and
if the tool is available:
reserving the tool for the period of time via generating a use reservation in the database, the use reservation indicating that the tool is to be used for the period of time;
generating a return reservation in the database, the return reservation indicating when the tool is to be returned;
when the tool is issued for the period of time, recording a time of tool issue in the database; and
when the tool is returned, recording a time of tool return in the database.

2. The method of claim 1, wherein the tool is assigned a tool identification number.

3. The method of claim 2, wherein the tool identification number is used to check the availability of the tool.

4. The method of claim 2, wherein the tool identification number is used to reserve the tool.

5. The method of claim 2, wherein the tool identification number is used to indicate that the tool is returned.

6. The method of claim 2, wherein the tool identification number is used to issue the tool.

7. The method of claim 1, wherein the wherein a location is used to check the availability of the tool.

8. The method of claim 1, wherein an item category is used to check the availability of the tool.

9. The method of claim 1, wherein the tool is one of a material tool and an equipment tool for performance of the service order.

10. A machine-readable medium storing a set of instructions, the set of instructions capable of being executed by a processor to implement a method for management of a tool, the instructions comprising:
creating a service order for the tool;
storing the service order in a database of a computer system, the database including tool data;
checking availability of the tool at a period of time via the database; and
if the tool is available:
reserving the tool for the period of time via generating a use reservation in the database, the use reservation indicating that the tool is to be used for the period of time;
generating a return reservation in the database, the return reservation indicating when the tool is to be returned;
when the tool is issued for the period of time, recording a time of tool issue in the database; and
when the tool is returned, recording a time of tool return in the database.

11. The machine-readable medium of claim 10, wherein the tool is assigned a tool identification number.

12. The machine-readable medium of claim 11, wherein the tool identification number is used to check the availability of the tool.

13. The machine-readable medium of claim 11, wherein the tool identification number is used to reserve the tool.

14. The machine-readable medium of claim 11, wherein the tool identification number is used to indicate that the tool is returned.

15. The machine-readable medium of claim 11, wherein the tool identification number is used to issue the tool.

16. The machine-readable medium of claim 10, wherein a location is used to check the availability of the tool.

17. The machine-readable medium of claim 10, wherein an item category is used to check the availability of the tool.

18. The machine-readable medium of claim 10, the tool is one of a material tool and an equipment tool for performance of the service order.

19. A method for tool management, the method comprising:
providing a service template via a computer system, the service template corresponds to a work environment activity and lists at least one tool required for performance of the work environment activity;
recording selection of the at least one tool in a database of the computer system;
checking for a period of time when the at least one tool is available via the database;
providing a notification of the period of time via the computer system; and
recording one of acceptance or rejection of the period of time in the database.
